(19) United States
(12) Patent Application Publication
(10) Pub. No.: US 2019/0279131 A1
(43) Pub. Date: Sep. 12, 2019

(54) VIRTUAL FIRM TECHNOLOGY - ABSTRACTION OF WORKERS

(71) Applicant: Toolots, Inc, Cerritos, CA (US)

(72) Inventors: ZeMing M. Gao, Irvine, CA (US); William Andreozzi, Irvine, CA (US)

(21) Appl. No.: 15/917,398

(22) Filed: Mar. 9, 2018

(51) Int. Cl. G06Q 10/06

(52) U.S. Cl. CPC G06Q 10/06313; G06Q 10/063112; G06Q 10/06311

(57) ABSTRACT

Virtual firm (VF) technology is disclosed, in which the abstraction of enterprise resources benefits the efficiency and scalability of the enterprises (firms). The technology includes a system that has a resource abstraction layer that defines virtual enterprise resources. The resource abstraction layer is configured to map the virtual enterprise resources to actual enterprise resources. An enterprise resource planning system provides workflows that contain tasks and assigns each of the tasks to one or more suitable virtual enterprise resources in the resource abstraction layer. The assigned tasks are each executed by one or more enterprise resources mapped to the respective one or more virtual enterprise resources. Virtualizable enterprise resources may include human workers and computational workers.

### BACKGROUND

In the full range of human activity, few concepts or existences are more important than “firm”. A firm is a business organization, such as a corporation, limited liability company or partnership, that provides goods or services. A single firm can consist of one or more establishments, as long as they fall under the same ownership. Although in the daily language the title “firm” is typically associated with professional business organizations such as law firms, in the language of economists the term “firm” is often used interchangeably with “business” or “enterprise” and is used for a wide variety or business operation units.

In economics, the theory of the firm attempts to explain the reasoning behind why firms exist, why they operate and produce as they do, and how they are structured. The theory changes as the economic marketplace changes. But no economics theory of the firm has had greater and more profound influence than a paper published in 1937 by Ronald Coase, a then British economist, who subsequently received the Nobel Prize for his theory of the firm.

In that paper, “The Nature of the Firm”, Ronald Coase pointed out that the standard model of economics, which focused on “the invisible hand” of the market force, failed to explain why people (entrepreneurs) would establish firms at all. His answer was that firms are a response to the high cost of using the force of the markets to conduct certain business transactions, such as hiring and contracting with someone to do a certain task. It is often cheaper to direct tasks by an implicit mandate or order than to negotiate and enforce separate contracts for every transaction. If hiring is a “transaction”, such a transaction incurs a cost. Such “transactional costs” are low in markets for standardized goods, in which a well-defined task can easily be put out to the market, where a contractor is paid a fixed sum for doing it. But very often simple contracts of this kind will not suffice. That is where the firm comes in. Instead of negotiating spot contracts, an employee enters into a long-term employment agreement to follow varied and changing instructions, up to agreed limits, for a relatively fixed salary. This lowers the transactional cost, which is considered fundamental in economics in the Coasian theory of the firm.

If the transactional cost is so fundamental, then designs or methods that may lower the transactional cost of hiring, employment or utilization of labor is also fundamentally important and desirable; and if that benefit is great enough, it may even drive fundamental changes in the structure of the firm to make a profound impact in the entire economy.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Disclosed is a virtual firm (VF) technology in which an abstraction of the enterprise resources benefits the efficiency of management and scalability of the enterprises (firms).

One embodiment is a system that facilitates enterprise resource management. The system has a resource abstraction layer that defines virtual enterprise resources. The resource abstraction layer is configured to map the virtual enterprise resources to actual enterprise resources. An enterprise resource planning system provides workflows that contain tasks and assigns each of the tasks to one or more suitable virtual enterprise resources in the resource abstraction layer. The assigned tasks are each executed by one or more enterprise resources mapped to the respective one or more virtual enterprise resources. Enterprise resources may include human workers and computational workers.

In one embodiment, the virtual enterprise resources include a virtual worker configured to be mapped to at least one human worker. In another embodiment, the virtual enterprise resources include a virtual worker configured to be mapped to at least one computational worker.

A virtual worker may be configured to be mapped to a group of at least two workers among the enterprise resources, the group of at least two workers sharing at least one common function. The virtual enterprise resources may include a virtual worker defined by a single function and may be configured to be mapped to a group of at least two workers that share the single function.

A virtual enterprise resources may include a virtual worker defined by a function matrix and may be configured to be mapped to a group of workers that share the function matrix.

In one embodiment, the virtual enterprise resources include a virtual worker responsive to a function call from the enterprise resource planning system. The virtual worker is configured to be mapped to a group of workers that have a dynamically variable number of workers without causing a substantial change to the virtual worker's response to the function call.

A virtual worker defined by a function matrix may be an abstraction of at least one actual worker, where the abstraction leaves out certain specific information of the actual worker not required by the function matrix.

In one embodiment, a virtual worker configured to be mapped to at least one worker among the enterprise resources may have a virtual worker driver that operates the virtual worker by emulating an operation of the actual worker. The actual worker may include a human worker, and the virtual worker driver may codify an abstract set of rules and policies of how the human worker is accessed, communicated to, and instructed to take an action.

In another embodiment, a plurality of virtual workers each responsive to a respective function call from the enterprise resource planning system are mapped to enterprise resources that include a plurality of worker profiles each characterized by a function matrix, wherein the mapping is made according to a match between each respective function call and a function in the function matrix of each worker profile.

Disclosed is also a method implemented by one or more computing devices to facilitate enterprise resource management, the method configures a resource abstraction layer having a plurality of virtual enterprise resources such that the virtual enterprise resources are mapped, or ready to be mapped, with a plurality of enterprise resources in an enterprise resource layer. The method provides, by a workflow generation component of an enterprise resource planning system, a workflow that contains a plurality of tasks. The method assigns, by a task assignment component of the enterprise resource planning system, each of the tasks to one or more suitable virtual enterprise resources in the resource abstraction layer. The method then allows the assigned tasks to be executed by one or more actual enterprise resources mapped to the respective one or more virtual enterprise resources.

Disclosed is also one or more computer-readable media storing executable instructions that, when executed by a processor, cause the processor to perform acts of the method disclosed herein.

### BRIEF DESCRIPTION OF THE FIGURES

The detailed description is described with reference to the accompanying figures. In the figures, the left-most digit(s) of a reference number identifies the figure in which the reference number first appears. The use of the same reference numbers in different figures indicates similar or identical items.

FIG. 1 is a schematic representation showing example components of a system that facilitates enterprise resource management using an abstraction layer of workers.

FIG. 2 is a schematic block diagram showing another system for facilitating enterprise resource management.

FIG. 3 is an example of a function matrix of a virtual worker.

FIG. 4 is a flow diagram of an example process for a method implemented by one or more computing devices to facilitate enterprise resource management.

### DETAILED DESCRIPTION

Overview

Applicants envision a firm structure that is fundamentally different from the conventional one in the Coasian framework, using a different way of hiring, employing or utilizing workers. Applicants disclose a system and method that use an abstraction layer of workers between the firm and the workers, which may be human workers or computational workers or both, to achieve virtualization of the firm. A “virtual firm (VF)” thus formed may have many advantages over the conventional firm.

The conventional firm is firstly “entitization” of human workers. For the past half century, the firm has experienced “softwarization”, of which the use of the ERP system is the best example. Applicants believe that the firm is about to start its next development, namely virtualization. The virtual firm (VF) technology disclosed herein enables the virtualization of the firm.

The evolution of the firm draws an analogy to the history of machines, which have evolved from mechanization to computerization, and presently virtualization.

However, despite the analogy between virtual machine (VM) and virtual firm (VF), and despite that VF will be built on a computational infrastructure including both hardware and software which may use virtual machine technology, the virtual firm technology described herein is a different domain as compared to the virtual machine. The concepts such as “abstraction”, “layer” and “driver” in the context of the virtual firm are not the same as that used in the context of the virtual machine. The latter are purely computer and software terminologies that describe a machine in the form of a computational system, while the former (as used in the present disclosure) describe a computerized management system of a mostly human organization. The virtual firm may have a cyber-physical nature, but is not a machine in the strict sense.

The virtual firm technology disclosed herein may so fundamentally reduce the transactional cost of hiring, employing or utilizing workers that it would shift or even disrupt the structure of the conventional Coasian firm. The virtual firm technology may not only impact the efficiency of the firm, but more importantly may also change the scalability of the firm.

In this description, the term “firm” refers to a business organization, such as a corporation, limited liability company or partnership, that provides goods or services. The term may be used interchangeably with “company”, “business” or “enterprise”.

The term “worker” refers to a person, a device, a machine, a tool, a robot or a software program that is capable to perform a task or function requested or needed by a firm. A “worker” therefore may be a human worker or a computational worker, and it may include but is not limited to an employee in a conventional sense. In addition, the term “worker” as used herein in relation to a human worker does not refer to the person as a whole, but instead refers to functional aspects of the person. In this sense, a person may appear to the system as multiple workers so far as the different functions that the person may perform are concerned.

The term “Enterprise Resource Planning (ERP)” refers to a computerized process by which a firm manages and integrates the important parts of its business such as planning, purchasing, inventory, sales, marketing, finance and human resources. However, because enterprise resources as described in this description include workers and a variety of services, and due to the broader meaning of “workers” and unique ways of engaging with and utilizing the workers, ERP in this disclosure has broader meaning than the conventional ERP management information system.

ERP can be thought of the glue that binds the different computer systems for a large organization. Without ERP, each department would have its own system optimized for that division's particular tasks. With ERP, each department still has its own system, but it can communicate and share information easier with the rest of the organization.

ERP may also be a relatively simple instance of software that provides ERP management to a smaller company, starting with basic human resource (HR) management, project management, client relationship management (CRM) and accounting.

The ERP collects information about the activity and state of different divisions of the firm (corporate) and makes this information available to other parts where it can be used productively. Information on the ERP can be added in real time by users. An authorized user with a valid password and access to the network can access the ERP system any time.

ERP's capacity transcends the collective ability of the individual parts to form a kind of corporate consciousness. By linking information about production, finance, distribution and human resources, ERP helps a corporation become more self-aware.

Therefore, from a software point of view, the ERP software functions like an operating system for a firm.

The system disclosed herein is used for implementing the method for facilitating enterprise resource management. The system may be a part of an application environment or ecosystem and be designed to perform its intended functions by communicating and interacting with other units and components thereof. The operation of the system is made possible by integrating hardware, software and electronic communications. Herein, a “unit”, “module”, or “component” may be a device, tool, machine or a software program designed to perform a task or function. A unit, the module or the component can be a piece of hardware, software, a plan or scheme, or a combination thereof, for effectuating a purpose associated with the task or function.

The method and the system for performing electronic payments are described in further detail using exemplary embodiments accompanying figures.

Exemplary Embodiments

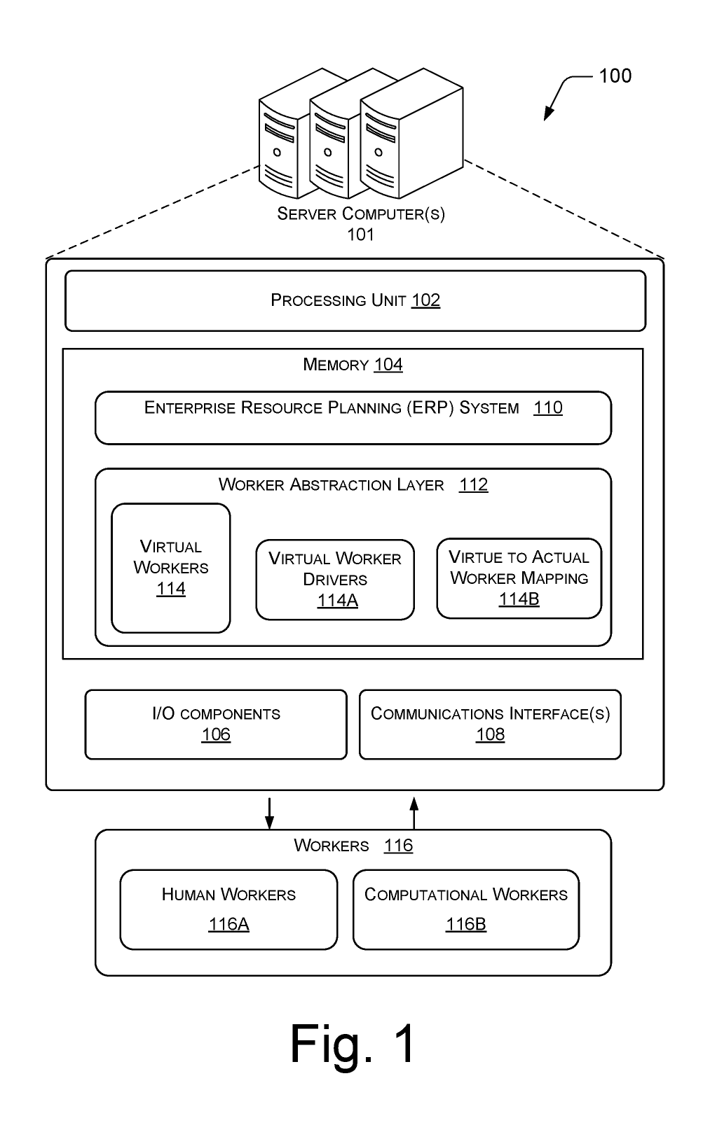

FIG. 1 is a schematic representation showing example components of a system that facilitates enterprise resource management using an abstraction layer of workers. The system 100 is implemented using computers, such as server computers 101 which may include a processing unit 102. The processing unit 102 represents one or more hardware processors each implemented with a single or multiple core design. Thus, the processing unit 102 may be implemented as a plurality of separate processors that function together as a unit to process instructions. The server computers 101 also include memory 104. In some implementations, the memory 104 may be implemented in hardware or firmware. The memory 104 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by a processing unit. The memory 104 encompasses computer-readable storage media which is non-transitory media that is capable of storing information such as computer instructions in formats other than transitory signals. The memory 104 may contain an operating system for controlling modules within the memory 104 as well as hardware of the server computers 101.

Input and output (I/O) components 106 are one type of hardware that may be a part of the server computers 101. The I/O components 106 may include such devices as monitors, keyboards, mice, speakers, printers, and the like. The server computers 101 may also include one or more communication interfaces 108 for receiving and sending information. The communication interfaces 108 may communicatively couple the server computers 101 to a communications network, such as a WAN or LAN, using any available networking protocol or technology.

If accessed remotely, I/O components 106 may just represent parts of communications interfaces 108, such as ports or interfaces that provide access to a user through such devices as monitors, keyboards, mice, speakers, printers, and the like.

The server computers 101 may be an on-premises computer, a network computer, or a computer or computer system provided through a cloud computing system. The server computers 101 may either be a physical machine, or a virtual machine instantiated by a virtual machine system.

The memory 104 includes multiple modules such as, but not limited to, a enterprise resource planning (ERP) system 110, and a worker abstraction layer 112, interfacing with workers 112, which may be human workers 112A or computational workers 112B. These modules contain computer-executable instructions, which when executed carry out acts or operations for the system 100 to facilitate desired enterprise resource management.

The worker abstraction layer 112 is an example of a resource abstraction layer that defines virtual enterprise resources based on actual enterprise resources. The worker abstraction layer 112 includes virtual workers 114, along with virtual worker drivers 114A and virtual-to-actual worker mapping 114B. In some implementation, virtual worker drivers 114A and/or virtual-to-actual worker mapping 114B may be integrated as a part of the virtual workers 114.

It should be noted that, in the conventional meaning of the term “enterprise resources”, there may be a broad range of them, but not all enterprise resources are virtualizable or desirable to be virtualized. For example, certain non-task specific or broader spectrum services may be used as enterprise resources but may be better accessed directly without virtualization through an abstraction layer. In the present disclosure, virtual enterprise resources generally refer to virtualization of the type of enterprise resources that are virtualizable or desirable to be virtualized. For example, virtual workers 114 are based on workers 116 that may be a person, a device, a machine, a tool, a robot or a software program that is capable to perform a task or function requested or needed by a firm. A “worker” in workers 116 may be a human worker or a computational worker and may include but is not limited to an employee in a conventional sense.

Specifically, the worker abstraction layer 112 is configured to map the virtual workers 114 to workers 116 through a virtual-to-actual worker mapping module 114B, which will be further described herein below. Enterprise Resource Planning system 110 operates virtual workers 114 through virtual worker drivers 104A, which will also be further described herein below.

Enterprise Resource Planning system 110 is configured to provide workflows. Each workflow may contain multiple tasks. Enterprise Resource Planning system 110 assigns each of the tasks to one or more suitable virtual workers 114 in the worker abstraction layer 112. The assigned tasks are each executed by one or more workers 116 mapped to the one or more virtual workers 114 assigned to the task.

Virtual workers 114 may include a virtual worker configured to be mapped to at least one human worker in workers 116, or include a virtual worker configured to be mapped to at least one computational worker in workers 116, or both.

Virtual workers 114 may include a virtual worker configured to be mapped to a group of multiple workers among workers 116. The group of multiple workers may share at least one common function for the linked virtual worker to work effectively.

In some cases, it may be desirable that some of virtual workers 114 be function-specific, in a sense that the virtual workers 114 may include a virtual worker defined by a single function. Such a function-specific virtual worker may be configured to be mapped to a group of multiple workers among workers 116. The group of multiple workers may share the single function for the function-specific virtual worker to work effectively. The single function may either be a combination of multiple subfunctions, or truly “atomic” in a sense that it may become impractical or unnecessary to further divide the function into subfunctions. For example, a function such as “sending a message to a certain endpoint (e.g., an email address)” may be atomic because it may be impractical or unnecessary to further divide such a function into subfunctions or other tasks.

The virtual workers 114 may include a virtual worker defined by a function matrix that includes a list of functions. Each function may be an ability to perform a certain task. The virtual worker can be configured to be mapped to a group of workers among workers 116. The group of workers preferably share the function matrix in order for the corresponding virtual worker to work effectively.

Preferably, the abstraction of virtual workers 114 leaves out certain specific information (such as personal identities) of the workers 116 not required by the function matrices that define the virtual workers 116.

However, the function matrix may include more than just a list of functions. In practice, enterprise resource planning system 110 may need to know not only what tasks a virtual worker can perform, but also how knowledgeable and versed the virtual worker is with the context of the task. Sometimes two tasks may appear to be the same in abstract or outside of context, but in reality may prefer to be assigned to a worker that has a certain contextual knowledge. Examples of such contextual knowledge is departmental knowledge (HR, corporate matters, sales, products, customer service, etc.), project type knowledge (categorized according to the type of projects undertaken), client knowledge (categorized according to the type of clients, or even specific client, that the task is related to), and role knowledge (categorized according to the type of a position or role taken by the virtual worker). Although it is an objective of the worker abstraction layer 112 to abstract out much of the specific information related to a particular worker 116, there is on the other hand a benefit to fine tune and contextualize the functions of virtual workers 114. More abstraction improves the scalability and reduces management cost of the ERP system 110, while a higher level of contextualization improves the efficiency of completing tasks. In practice, a balance needs to be struck according to the actual scale and requirements of the system. However, it is envisioned that the specifics of the function matrix of a virtual worker 114 should preferably not include any personal identification information which may uniquely belong to a human worker 106A.

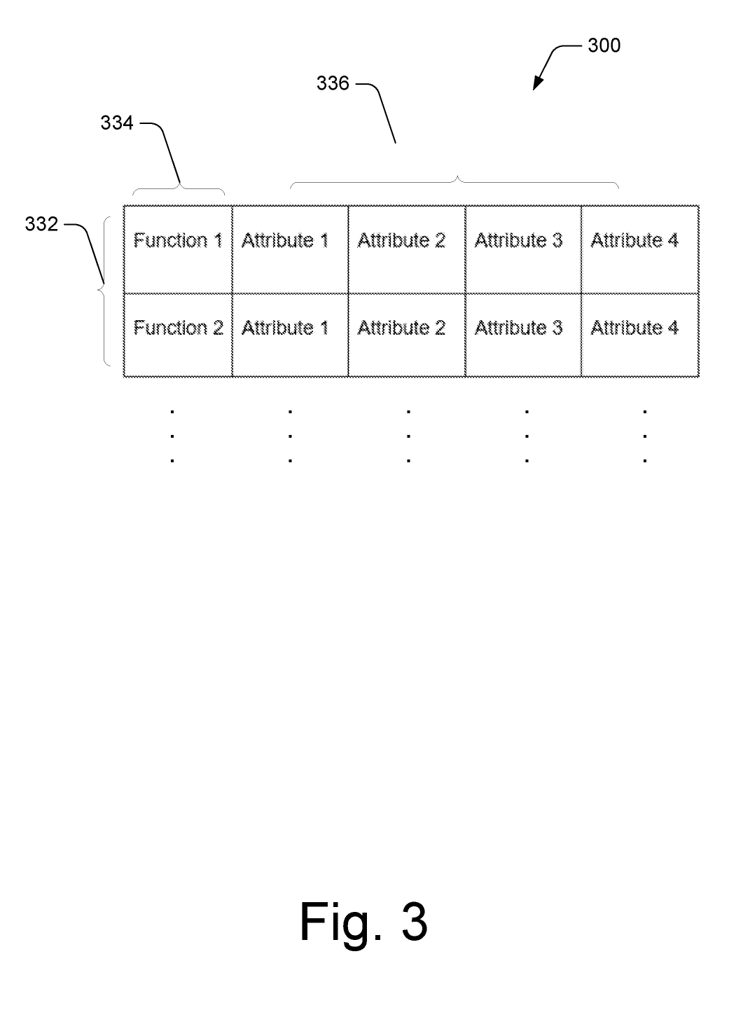

One way to implement the function matrix of virtual worker 114 is to use a data table as shown in FIG. 3.

FIG. 3 is an example of a function matrix of virtual worker 114. Data table 300 represents the function matrix of one of the virtual workers 114. Data table 300 may have one or more rows 332 in a collective data table of many virtual workers 114. Data table 300 has multiple columns (fields). The first column 334 may be used to define a function that can be performed by the virtual worker 114, and the rest of the columns 336 may each attribute into a certain type of contextual information, such as departmental knowledge, project type knowledge, client knowledge, and role knowledge etc. Each field may have a value, which may be either descriptive (e.g. textual) or numerical/quantitative, but a field may be allowed to be empty. If the virtual worker 114 may perform multiple functions, its function matrix may include multiple rows, each representing a single function.

Returning to FIG. 1, each virtual worker 114 may be responsive to a function call from the enterprise resource planning system 110. Accordingly, the virtual worker 114 can be configured to be mapped to a group of workers among the workers 116. Mapping of virtual workers 114 to workers 116 may be done using virtual-to-actual worker mapping module 114B. Such mapping may not have a one-to-one relationship, as more than one workers 116 may share the same function that is defined in abstract in a function matrix of a virtual worker 114, and conversely a worker 116 may have multiple functions that correspond to multiple virtual workers 114. The mapping may be done based on a finding of a certain level match between the function matrix of a virtual worker 114 and the functions that can be performed by a worker 116. Preferably, a match should be found at least at the primary function level, such as the function defined in the first column 334 in at least one row 332 (FIG. 3). Finding of a further match in other attribute columns 336 may indicate a more perfect match. As you may be set up to rank the match level from the most specific to the least specific.

In one embodiment, the group of workers 116 may have a dynamically variable number of workers without causing a substantial change to the virtual worker's response to the function call. For example, when the virtual worker 114 is defined by a function, a set of functions, or a function matrix, the virtual worker 114 may be mapped to more workers from workers 116 that share the defining function(s) without changing the function(s) of the virtual worker 114. With the function(s) remaining the same, the virtual worker 114 does not substantially change its behavior in responding to a functional call by the ERP system 110, except that if the number of mapped workers 116 has been increased, the scale of performing the function(s) by the virtual worker 114 is also increased. In addition, if a member among workers 116 that can perform the same function(s) more efficiently is added, the corresponding virtual worker 114 also acquires a higher efficiency in performing the function(s).

The virtual worker drivers 114A in the worker abstraction layer 112 operate the virtual workers 114. The process of abstracting the workers is done from the perspective of ERP system 110, which is analogous to the operating system in the virtual machine domain. To achieve abstraction of workers 116, a virtual worker 114 and an accompanying virtual worker driver 114A may include sets of routines in software that emulate some actual worker-specific functions. Alternatively, a virtual worker 114 and an accompanying virtual worker driver 114A may synthetically create a new kind of abstract worker which bears no apparent relation to the underlying worker 116 that is ultimately called to perform a function. Either way, the worker abstraction layer 112 gives all applications in the system 100 access to the actual resources (workers 116) through the ERP system 110 without requiring each application to directly interfacing with the actual resources. This is advantageous because a direct interface which would require complete knowledge of the actual worker-specific details such as how each worker 116 communicates with the rest of the system 100, and hence would be a burden not only for the ERP system 110, but also at each application level.

Worker abstraction layer 112 thus allows the creation of specific worker-independent, high performance applications by providing standard ERP calls to workers.

In one embodiment, a virtual worker 114 and an accompanying virtual worker driver 114A emulate an operation of the workers 116A mapped to the virtual workers 114 when worker abstraction layer 112 is not applied. If a particular virtual worker 114 is mapped to a human worker, for example, the virtual worker driver 114A preferably codifies an abstract set of rules and policies of how the human worker is accessed, communicated to, and instructed to take an action. Preferably, the abstract set of rules and policies do not need to include all aspects of the employment agreements of every worker 116 that has been mapped to the particular virtual worker 114. Instead, only a common denominator of rules and policies shared by the workers 116 that have been mapped to the particular virtual worker 114 may need to be included in the virtual worker driver 114A. For example, if the group of workers 116 collectively cover an all-time availability (meaning that at any given time, at least one worker 116 is available), then the virtual worker driver 114A needs not to have a policy that prohibits calling for a virtual worker 114 to do a certain task during a certain after work hours, neither does it need to take overtime payment into consideration.

The communication methods such as contacts (email, telephone, etc.) are also abstracted for easier management. For example, the ERP system 110 may decide to call or email the virtual worker 114. In doing so, the virtual worker driver 114A does not need to contain specific phone numbers or email addresses that belong to a particular worker 116 in order to issue instructions to the worker 116, but instead may call a virtual number or email to a virtual email address, or use certain aliases, that are provided by the ERP system 110, which then automatically routes the call or the email message to the worker 116 who has been signed to the task related to the function call. This streamlines the communications procedures and makes room for higher level of automation as well.

In one embodiment, each of the virtual workers 114 may be responsive to a respective function call from the enterprise resource planning system 110, and the workers 116 may each have a worker profile characterized by a function matrix. The worker abstraction layer 112 is configured to map the virtual workers 114 to workers 116 based on finding a match between each respective function call and a function in the function matrix of each worker 116's worker profile. The worker profiles may either be a human worker profile or a computational worker profile.

As a new worker's profile is added to the workers 116, the worker abstraction layer 112 may be configured to automatically update the virtual workers 114 to be mapped with the new worker profile added. Adding a new worker to the workers 116 in real life may involve a process of onboarding the new worker as a new hire or contractor. The new worker may need to sign an employment agreement or contractor agreement, and a worker profile is created and added to a computer managed record system for workers 116.

As a new worker profile having a new function is added to the worker profiles of workers 116, the virtual workers 114 is automatically updated to include a new virtual worker who may respond to a function call corresponding to the new function in the new worker profile.

In another embodiment, the worker abstraction layer 112 is configured to create a mapper that performs virtual-to-actual worker mapping to map virtual workers 114 to workers 116. The mapper has a virtual-to-actual worker mapping module 114B that is stored in the worker abstraction layer 112 and is responsive to the enterprise resource planning system 110 in assigning tasks to suitable virtual enterprise workers 114. The abstraction layer 112 may be configured to dynamically map a relevant virtual worker 114 to the workers 116 in response to a function call by the enterprise resource planning system 110 in assigning the task to a suitable virtual worker.

In addition to abstracting workers 116 into virtual workers 114 and matching virtual workers 114 with task-related function calls, ERP system 110 may also automatically place the virtual worker 114 selected to perform a task into a proper ERP environment that provides the virtual worker 114 access to information that is necessary or useful in performing the task. In doing so, preferably information that may be deemed too sensitive to be disclosed may be filtered out. A differentiated data access policy may be formulated for this purpose. One way to implement such a policy is to add to the function matrix 300 one or more fields (attributes) to delineate data sensitivity levels or the types of data that can be accessed by the particular virtual worker as defined by the function matrix. Accordingly, the worker profiles that describe the workers 116 may also include similar fields (attributes) to delineate data sensitivity levels given to each worker, so that mapping or matching of the virtual workers 114 to workers 116 may take the data sensitivity and access policy into account.

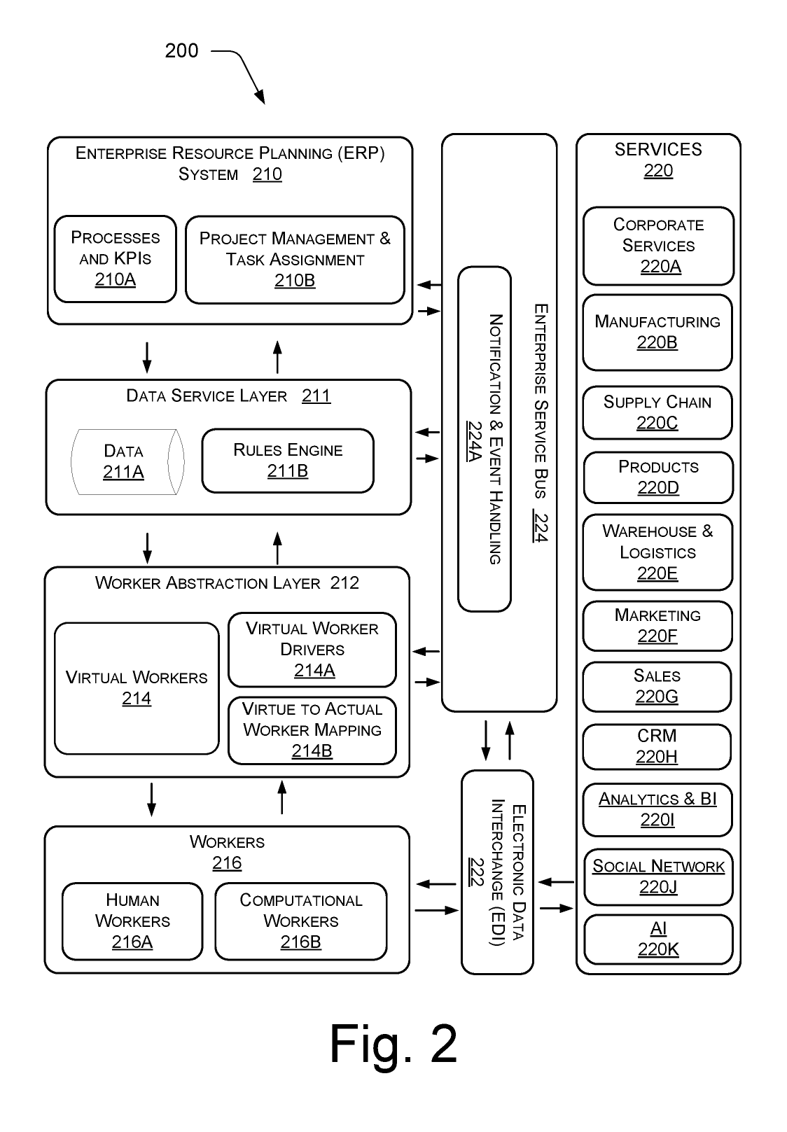

FIG. 2 is a schematic block diagram showing another system for facilitating enterprise resource management. The system 200 is similar to system 100, but has more details and more features.

Enterprise resource planning (ERP) system 210 is similar to ERP system 110. Worker abstraction layer 212 is similar to worker abstraction layer 112. Virtual workers 214, virtual worker drivers 214A, and virtual-to-actual worker mapping 214B are similar to virtual workers 114, virtual worker drivers 114A, and virtual-to-actual worker mapping 114B, respectively. Workers 216, human workers 216A, and computational workers 216B are similar to workers 116, human workers 116A, and computational workers 116B, respectively.

ERP system 210 has a processes & KPIs module 210A for creating and managing processes and key performance indicators (KPI), and a project management & task assignment module 210B for creating and managing projects and assigning tasks to virtual workers 214.

A data service layer 211 helps the ERP system 210 to create and manage projects and assign tasks. A rules engine 211B manages and applies business rules to all applicable processes, projects, tasks and assignments conducted by the ERP system 210. The data service layer 211 handles all information coming from the ERP system 210.

In addition to the core services provided by the ERP system 210, many services may be added to system 200, such as service modules included in services 220, namely corporate services 220A, manufacturing 220B, supply chain 220C, products 220D, warehouse & logistics 220E, marketing 220F, sales 220G, CRM 220H, analytics & BI (business intelligence) 220I, social network 220J, and AI (artificial intelligence) 220K.

As presented in FIG. 2, in system 200, all above service modules other than the core ERP services are provided as plug-in services. However, alternatively, any of these services may be integrated into the ERP system 210 to form a monolithic ERP system.

For scalability considerations, a service-oriented architecture (SOA) may be preferred. The SOA architecture uses an enterprise service bus 224 to handle all information coming from plug-in services 220 via an electronic data interchange (EDI) layer 222.

The data service layer 211 further handles all information from enterprise service bus 224 via an EDI layer 222, and then routes information based on business rules using rules engine 211B. Business rules may be managed by a mediator.

Data is stored in data 211A which may be a storage or storage system using any visible Storage Technology. An actual audit of the applications of ERP system 210 and services 220 and their use of data determines where data lives in system 200. Using SOA architecture, the system 200 may be established as a plug-and-play system, in which not any one specific application (service) is required, and any can be chosen from, as long as they satisfy the EDI requirements for that event category. In other words, the system 200 may be dynamic, in which any application or service provider can tap into the data service layer 211 through EDI 222 and enterprise service bus 224. Any new application service would register itself as a consumer or provider of certain information, which could then be surfaced through plain endpoints for other systems that provide a service (services 220) and/or subscribe to such services.

In one embodiment, the data service layer 211 conducts audits of all of the data, the routing of data and business logic.

For reading data, it may at first seem like a performance hit by having to pull data from across multiple systems (services 220), but flattening the data into a flat database system for near real-time retrieval is a potential advantage of the system 200 using an SOA architecture. The systems that can provide this feature include SOLR/Elasticsearch and MongoDB/Hadoop. If some level of hierarchical relationship within the data to minimize duplicate data across every record/document is desired, SOLR/Elasticsearch is a better option.

Analytics & business intelligence (BI) module 220J may provide data analytics based on data from service 220 may combine to provide new verticals for monetization of the business intelligence collected by the system 200.

For writing data, the system 200 with SOA has advantages, including, most importantly, unlimited scalability with the greatest flexibility. All business rules will be managed through the data service layer 211 and can easily be updated without compromising the reliability of the system 200. In order to ensure high availability, all write transactions across different systems may be performed through queuing platform such as AWS SQS, which may use a dedicated cluster of servers to manage queues.

One function of the data service layer 211 is to provide and manage the analytics and business intelligence back into ERP system 210 and services 220 with the goal of optimizing workflows and process.

Another function of the service layer 211 is to work with worker abstraction layer 212 to virtualize enterprise resources such as workers 216 that have registered (on-boarded) themselves to the system 200 through ERP system 210 or services 220. For example, as the ERP system 210 provides or is provided a task to perform, the data service layer 211 may work with worker abstraction layer 212 to determine what type of virtual resources (virtual workers 214) are available for that task. ERP system 210 then communicates to registered workers 216 that are mapped to the suitable virtual resources (virtual workers 214) to handle that task. Workers 216 would then provide feedback through the data service layer 211 to ERP system 210, which manages resource allocation and business process operations. The actual resources (workers 216) may either be directly managed by the ERP system 210 or managed by a plug-in service such as a dedicated workers service agent.

ERP system 210 manages business processes by providing workflows that contain the steps necessary to complete a function. Every step is assigned to a a virtual worker selected from virtual workers 214, and ultimately a suitable actual worker selected from workers 216 that is accountable for the execution and delivery of any sub-steps. For simple workflows the virtual worker assignment is inherited by the parent worker assignment. For more complex workflows that involve one or more dependencies, a new virtual worker would be assigned to this step within the context of the workflow.

For the purpose of scalability, certain level of automation in the resource assignment is preferred over manual identification and selection of resources. Manual selection per task that may then involve a new resource to identify and select another resource for a sub-task will be a hurdle for a larger scale platform business that collectively may have hundreds of business operations being performed at any given minute.

In order to support this exponential cascade of e tasks and vents, project management & task assignment module 210B preferably automates both the identification and assignment of resources based on type and availability. This can be handled by a simple rules-based decision matrix or some other more sophisticated methods. In some cases, it may be beneficial to first determine whether the current task requires a human worker 216A versus computational worker 216B, and once the resource type has been determined, the resource management system for the required resource type would be notified of this event.

A human worker 216A may be an employee or contractor that has been on-boarded into the system. A computational worker 216B may be one in which some application or utility can handle the execution and delivery with no human effort. An example of the computational worker would be a service with API available that can be used to perform the task. The worker will be given just enough information to complete the task. The information that is required to complete each step of a process would be determined through a contract or agreement that has been assigned to both the worker and the task type.

The management for computational workers follow normal EDI standards and existing endpoint contacts would be used to transform data into the proper format for the published API. Assignment of tasks can be made standard and would scale based on the traditional auto-scaling and monitoring tools available for the underlying infrastructure being used.

The management for human workers may follow a methodology that a department manager would use to manually assign personnel, except that with the system 200, the project management & task assignment module 210B (which acts as or on behalf of a manager) do not look at the actual workers 216 directly but indirectly via the virtual workers 214 that are mapped to the actual workers 216. The system 200 would look at current workers that are capable of handling the task type and then include additional information, including but not limited to information regarding availability, cost, predicated time of completion with probability of success within that time, and scheduled time that this task must be completed. After that, the project management & task assignment module 210B would assign the task accordingly, and may also communicate the resource identification back to the ERP system 210 or the service in services 220 from which the task was originated.

Notification and Event Handling—For the purposes of this document, Event and Task are synonymous. The system 200 uses an enterprise service bus 224 which has a notification and event handling module 224A to provide a potential solution to some key problems regarding scalability, such as support for dynamic resources (e.g., freelancers, full-time employees, contractors or computational workers such as automated apps or systems).

Monolithic ERP applications scale and perform well for fixed-resource organizations, but much larger industry based systems with dynamic resources across multiple organizations may require that both resources (workers) and applications (services) can plug-and-play. In order to support a plug-and-play architecture between the system and event handlers, communication of events and notifications should be “connectionless”. This means that the communication layer supports a mechanism that allows for the system to “send once” and zero or more listeners would handle the message. To keep the “noise” as low as possible, ideally the solution would follow a subscription-like methodology and have the ability to be prioritized by existing switching standards (such as the layer 2 switching standard).

An example of such a protocol that already exists is multicasting.

In the system 200, enterprise service bus 224 may leverage multicast groups for the transmission of information payloads. Multicast groups may be categorized (e.g., legal, HR, warehouse, accounting, sales etc.) and with each group being given a unique IP address based on administratively scoped addresses for multicast.

For simplicity, a “payload” is a defined schema of information that contains all necessary information that is required (and authorized) for the given handler types that subscribe to the respective multicast group.

Due to the nature of multicast, RSVP protocols exist for prioritization as well as other practices that can be used to provide additional levels of security. This payload also contains information required for the handler to acknowledge receipt of the payload. To maintain a connectionless configuration, the acknowledgment would be a UDP packet that is sent out to the data service layer 211. The acknowledge receipt would contain all of the necessary information for the data service layer 211 to properly update the underlying ERP system.

To support for dynamic resources (e.g., pooled workers 216 that are dynamically changing), the system 200 provides a solution where the data service layer 211 routes an event to the ERP system 210 (more specifically to the project management & task assignment module 210B), while worker abstraction layer 212 decouples the resource management of ERP system 210 from the actual resources (workers 216) that are available. This abstracts the resources (workers 216) from the system.

The ERP system 210 would be responsible for ensuring that any resource listed as available would have already been on-boarded. Preferably, on-boarded would have the same meaning across the system 200 for all human workers 216A. More specifically employees would have been hired, freelancers or contractors would have proper contracts signed, and the on-boarded information including contractual terms would be recorded in the system 200.

Automated resources (computational workers 216B) would also have been brought online in order to be regarded as being available.

In the following, multicast is further illustrated using computational workers as an example.

Computational workers 216B are resources that perform very specific automated tasks. An example is “going to a website, fill-in form and submit”—a task that can be automated. Generally, a computational worker may be architected to include a service endpoint that provides access to the computational worker.

As applied in system 200 that has a worker abstraction layer 212, the computational workers 216B may each have its own built-in service endpoint to provide a program-to-program interface, and the corresponding virtual workers 214 that are mapped to respective computational workers 216B may also have their own endpoint to provide a program-to-program interface. The endpoint of the virtual worker 214 is preferably at a higher abstraction level than the service endpoint the computational workers 216B, and it may be incorporated into the respective virtual worker driver 214A.

The endpoint of the virtual worker 214 that is assigned to the event manages all incoming and outgoing communications from the ERP system 210 and data service layer 211 to the corresponding virtual worker 214 and the computational worker 216B that is mapped to the virtual worker 214. A queue mechanism is used to ensure there is no loss of information. The endpoint the virtual worker 214 receives an event (which are sent from the enterprise service bus 224), pushes it to a “receive queue”, as well as pushes any pending events from the “send queue” to the enterprise service bus 224. The endpoint receives a status update from the assigned computational worker 216B to indicate that the task is completed.

The computational worker 216B monitors the “receive queue” and executes the necessary functions assigned to the computational worker 216B. Any status results would be pushed to a “send queue” for acknowledgments, notifications or status updates.

Based on this architecture, ERP system 210 and data service layer 211 have no specific knowledge of the computational worker 216B. The endpoint of the virtual worker 214 knows about the events (which are sent from the enterprise service bus 224), and interfaces with computational worker 216B.

The source address of the event would be included in the payload. The endpoint the virtual worker 214 receives the payload and pushes to the “receive queue” sends a “new message” event notification to the computational worker 216B. The virtual worker 214 processes the “receive queue” by iterating through all the events. Upon each iteration, the virtual worker 214 pushes an acknowledge receipt to the “send queue”, then instructs the computational worker 216B to perform the automated task. After the task is completed, the service endpoint of the computational worker 216 pushes a status message to the “send queue” via worker abstraction layer 212 to enterprise service bus 224, which then finally marks the queued item as completed. The status message can be any sort of status, such as “working”, “blocked”, “completed” etc. and would contain any necessary information to provide details.

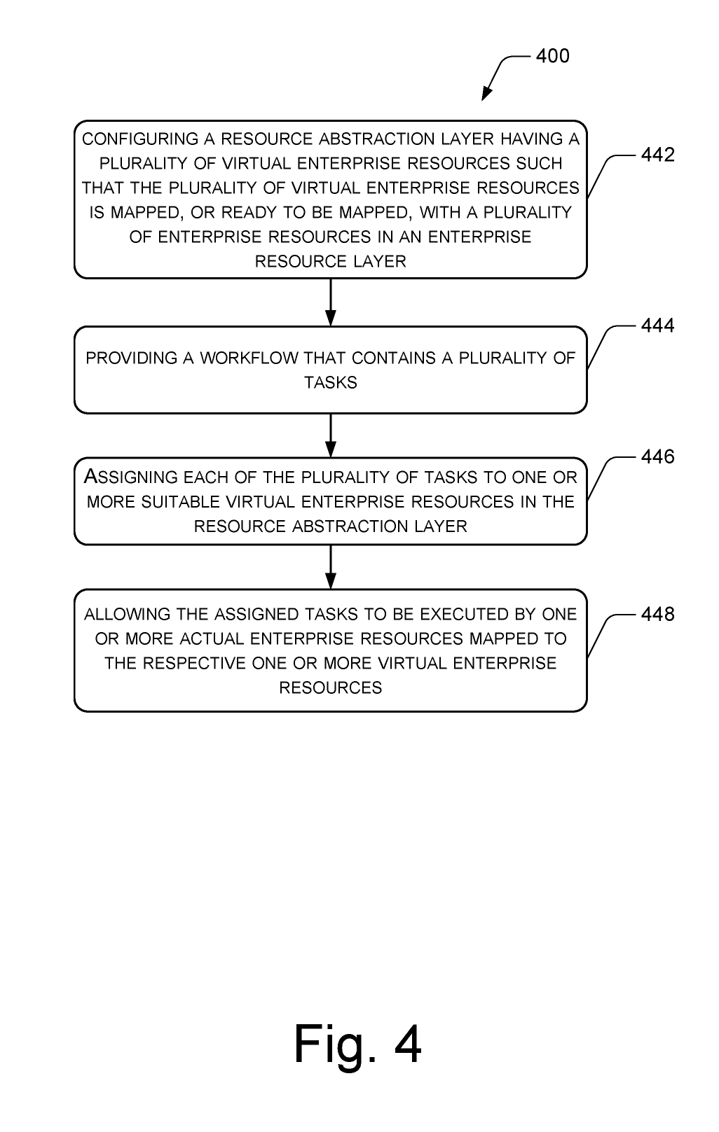

FIG. 4 is a flow diagram of an example process 400 for a method implemented by one or more computing devices to facilitate enterprise resource management.

At 442, an act of configuring a resource abstraction layer having a plurality of virtual enterprise resources takes place. The plurality of virtual enterprise resources is mapped, or ready to be mapped, with a plurality of enterprise resources in an enterprise resource layer. Examples of the enterprise resources are workers 116 and workers 216 described in FIGS. 1 and 2.

At 444, a workflow generation component of an enterprise resource planning system provides a workflow that contains a plurality of tasks. An example of the workflow generation component is the project management & task assignment module 210B in the enterprise resource planning system 210 in FIG. 2.

At 446, a task assignment component of the enterprise resource planning system assigns each of the plurality of tasks to one or more suitable virtual enterprise resources in the resource abstraction layer. An example of the task assignment component is the project management & task assignment module 210B in the enterprise resource planning system 210. Examples of the resource abstraction layer are worker abstraction layer 112 and worker abstraction layer 212 as described in FIGS. 1 and 2.

At 448, a system implemented with the method allows the assigned tasks to be executed by one or more actual enterprise resources mapped to the respective one or more virtual enterprise resources. Examples of the system are the system 100 and the system 300 described in FIGS. 1-3. Examples of actual enterprise resources or workers 116 and workers 216 in FIGS. 1 and 2.

In one embodiment, at least one of the plurality of virtual enterprise resources may be mapped, or ready to be mapped, with a human worker included in the plurality of enterprise resources. In another embodiment, at least one of the plurality of virtual enterprise resources is mapped, or ready to be mapped, with a computational worker included in the plurality of enterprise resources. Examples of a human worker or human workers 116A and human workers 216A.

The method may also comprise an act of making a function call to the abstraction layer by the enterprise resource planning system, for each task. The plurality of virtual enterprise resources may include a plurality of virtual workers responsive to each respective function call. The act of assigning each of the plurality of tasks to one or more suitable virtual enterprise resources may include the following: for each task, identifying the one or more suitable virtual enterprise workers responsive to the function call; and assigning the identified virtual enterprise workers to the respective task.

The above described method may be stored on one or more computer-readable media as executable instructions that, when executed by one or more processors, cause the one or more processors to perform acts described above. Examples of one or more computer-readable media are memory 104 and memory 204 in FIGS. 1 and 2.

Conclusion

More than 80 years have passed since Coase pointed out the interplay or competition between the invisible hand of the market mechanism and the benign “dictatorship” of the firm. The boundary between the two might have since become blurrier. The share of self-employed contractors in the labor force has risen. The “gig economy” exemplified by Uber drivers is mushrooming. Along with the rising platform economy, a new kind of firm structure leaning toward a new kind of employment relationship is emerging. Yet it is still the transactional cost that plays a fundamental role. The virtual firm technology disclosed herein promises to fundamentally lower the transactional cost of employment, and thus become the enabling technology and a driving force for a new economy.

In essence, the virtual firm technology transforms the transactional cost of employment using virtualization and creates a new space in which such transactional cost may be collectively optimized, automated and redistributed. The technology may define a space for coordinated and computerized production in between those of the market mechanism and the conventional firm.

It should be further noted that although a system and method of virtualization of workers to form a virtual firm is disclosed herein, it does not suggest that any firm that implements such a system and method will need to virtualize its entire workforce. In some implementations, virtualization may be applied over some workers of the firm's workforce, leaving the rest of the workers managed by a conventional method, such as a conventional enterprise resource planning system. The transition from physical firm to virtual firm may be made gradual. For example, while using an integrated enterprise resource planning system to manage both virtual workers and the traditional workers at the same time, more workers may be virtualized and gradually incorporated into the virtual firm portion as the firm sees fitting.

In this description, the order in which a process is described is not intended to be construed as a limitation, and any number of the described process blocks may be combined in any order to implement the method, or an alternate method.

It is appreciated that the potential benefits and advantages discussed herein are not to be construed as a limitation or restriction to the scope of the appended claims.

These processes discussed above are each illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A system that facilitates enterprise resource management, the system comprising:
one or more memories storing computer-executable instructions of:
a resource abstraction layer defining a plurality of virtual enterprise resources, the resource abstraction layer being configured to map the plurality of virtual enterprise resources to a plurality of enterprise resources; and
an enterprise resource planning system that is configured to provide a workflow containing a plurality of tasks and assign each of the plurality of tasks to one or more suitable virtual enterprise resources in the resource abstraction layer, wherein the assigned tasks are each executed by one or more enterprise resources mapped to the respective one or more virtual enterprise resources; and
one or more processors for executing the computer-executable instructions stored in the memory.

2. The system as recited in claim 1, wherein the plurality of virtual enterprise resources includes a virtual worker configured to be mapped to at least one human worker included in the plurality of enterprise resources.

3. The system as recited in claim 1, wherein the plurality of virtual enterprise resources includes a virtual worker configured to be mapped to at least one computational worker included in the plurality of enterprise resources.

4. The system as recited in claim 1, wherein the plurality of virtual enterprise resources includes a virtual worker configured to be mapped to a group of at least two workers among the plurality of enterprise resources, the group of at least two workers sharing at least one common function.

5. The system as recited in claim 1, wherein the plurality of virtual enterprise resources includes a virtual worker defined by a single function, the virtual worker being configured to be mapped to a group of at least two workers among the plurality of enterprise resources, the group of at least two workers sharing the single function.

6. The system as recited in claim 1, wherein the plurality of virtual enterprise resources includes a virtual worker defined by a function matrix, the virtual worker being configured to be mapped to a group of workers among the plurality of enterprise resources, the group of workers sharing the function matrix.

7. The system as recited in claim 1, wherein the plurality of virtual enterprise resources includes a virtual worker responsive to a function call from the enterprise resource planning system, the virtual worker being configured to be mapped to a group of workers among the plurality of enterprise resources, the group of workers having a dynamically variable number of workers without causing a substantial change to the virtual worker's response to the function call.

8. The system as recited in claim 1, wherein the plurality of virtual enterprise resources includes a virtual worker defined by a function matrix, the virtual worker being an abstraction of at least one worker included in the plurality of enterprise resources, the abstraction leaving out certain specific information of the at least one worker not required by the function matrix.

9. The system as recited in claim 1, wherein the plurality of virtual enterprise resources includes a virtual worker configured to be mapped to at least one worker among the plurality of enterprise resources, and the virtual worker has a virtual worker driver that operates the virtual worker by emulating an operation of the at least one worker.

10. The system as recited in claim 9, wherein the at least one worker includes a human worker, and the virtual worker driver codifies an abstract set of rules and policies of how the human worker is accessed, communicated to, and instructed to take an action.

11. The system as recited in claim 1, wherein the plurality of virtual enterprise resources includes a plurality of virtual workers each responsive to a respective function call from the enterprise resource planning system, the plurality of enterprise resources includes a plurality of worker profiles each characterized by a function matrix, and the resource abstraction layer is configured to map the plurality of virtual workers to the plurality of worker profiles according to a match between each respective function call and a function in the function matrix of each worker profile.

12. The system as recited in claim 11, wherein the plurality of worker profiles includes a human worker profile.

13. The system as recited in claim 11, wherein the plurality of worker profiles includes a computational worker profile.

14. The system as recited in claim 11, wherein resource abstraction layer is configured to automatically update the plurality of virtual workers to be mapped with a new worker profile added to the plurality of worker profiles.

15. The system as recited in claim 11, wherein the plurality of virtual workers is automatically updated to include a new virtual worker when a new worker profile having a new function is added to the plurality of worker profiles, wherein the new virtual worker responds to a function call corresponding to the new function.

16. The system as recited in claim 1, wherein the resource abstraction layer is configured to create a mapper that maps the plurality of virtual enterprise resources to a plurality of enterprise resources, the mapper being stored in the resource abstraction layer and responsive to the enterprise resource planning system in assigning each of the plurality of tasks to one or more suitable virtual enterprise resources.

17. The system as recited in claim 1, wherein the resource abstraction layer is configured to dynamically map a relevant virtual enterprise resource in the plurality of virtual enterprise resources to the plurality of enterprise resources in response to a function call by the enterprise resource planning system in assigning each of the plurality of tasks to one or more suitable virtual enterprise resources.

18. A method implemented by one or more computing devices to facilitate enterprise resource management, the method comprising:
configuring a resource abstraction layer having a plurality of virtual enterprise resources such that the plurality of virtual enterprise resources is mapped, or ready to be mapped, with a plurality of enterprise resources in an enterprise resource layer;
providing, by a workflow generation component of an enterprise resource planning system, a workflow that contains a plurality of tasks;
assigning, by a task assignment component of the enterprise resource planning system, each of the plurality of tasks to one or more suitable virtual enterprise resources in the resource abstraction layer; and
allowing the assigned tasks to be executed by one or more actual enterprise resources mapped to the respective one or more virtual enterprise resources.

19. The method as recited in claim 18, wherein at least one of the plurality of virtual enterprise resources is mapped, or ready to be mapped, with a human worker included in the plurality of enterprise resources.

20. The method as recited in claim 18, wherein at least one of the plurality of virtual enterprise resources is mapped, or ready to be mapped, with a computational worker included in the plurality of enterprise resources.

21. The method as recited in claim 18, further comprising:
for each task, making a function call to the abstraction layer by the enterprise resource planning system,
wherein the plurality of virtual enterprise resources includes a plurality of virtual workers responsive to each respective function call, and
the act of assigning each of the plurality of tasks to one or more suitable virtual enterprise resources comprises:
for each task, identifying the one or more suitable virtual enterprise workers responsive to the function call; and
assigning the identified virtual enterprise workers to the respective task.

22. One or more computer-readable media storing executable instructions that, when executed by one or more processors, cause the one or more processors to perform acts comprising:
configuring a resource abstraction layer having a plurality of virtual enterprise resources such that the plurality of virtual enterprise resources is mapped, or ready to be mapped, with a plurality of enterprise resources in an enterprise resource layer;
providing, by a workflow generation component of an enterprise resource planning system, a workflow that contains a plurality of tasks;
assigning, by a task assignment component of the enterprise resource planning system, each of the plurality of tasks to one or more suitable virtual enterprise resources in the resource abstraction layer; and
allowing the assigned tasks to be executed by one or more actual enterprise resources mapped to the respective one or more virtual enterprise resources.
